(19) United States
(12) Patent Application Publication
(10) Pub. No.: US 2020/0285250 A1
(43) Pub. Date: Sep. 10, 2020

(54) MONITORING OBJECTS OF INTEREST

(71) Applicant: Ford Global Technologies, LLC, Dearborn, MI (US)

(72) Inventors: Juan Enrique Castorena Martinez, Southfield, MI (US); Codrin Cionca, Ann Arbor, MI (US); Mostafa Parchami, Dearborn, MI (US); Linjun Zhang, Canton, MI (US)

(73) Assignee: Ford Global Technologies, LLC, Dearborn, MI (US)

(21) Appl. No.: 16/296,887

(22) Filed: Mar. 8, 2019

(51) Int. Cl. G05D 1/02; G05D 1/10; G08G 5/00; B64C 39/02

(52) U.S. Cl. CPC G05D 1/0276; G05D 1/104; G08G 5/0034; G05D 2201/0213; B64C 39/024; B64C 2201/123; B64C 2201/146; G08G 5/0069

(57) ABSTRACT

A situational awareness system is described that comprises a processor and memory storing instructions executable by the processor. The instructions comprise to: determine at least one object of interest relative to a target vehicle; determine an assignment optimization at least one of a plurality of mobile devices to the at least one object of interest; and assign the at least one of the plurality of mobile devices to the at least one object of interest.

### BACKGROUND

Vehicles often rely on sensor data for operation. For example, sensors such as cameras, radar, lidar, ultrasound, etc., can provide data for identifying objects, e.g., road signs, other vehicles, pedestrians, etc., and road conditions, e.g., ice, snow, cracks, potholes, bumps, etc. Sensors provide data within a sensor field of view.

### BRIEF DESCRIPTION OF THE DRAWINGS

FIG. 1 is a schematic diagram of an exemplary situational awareness system that includes a gateway system and a plurality of mobile devices for providing, to a target vehicle, information to assist the vehicle in autonomous driving.

FIG. 2 is a schematic diagram of an example of the gateway system.

FIG. 3 is a side view of an example of one of the mobile devices.

FIG. 4 is a schematic diagram of one of the mobile devices shown in FIG. 3.

FIG. 5 is a schematic diagram similar to FIG. 1, however, also illustrating a frame of reference.

FIG. 6 is an exemplary process for optimizing a determination of assigning mobile devices to one or more objects of interest.

FIGS. 7-8 illustrate exemplary matrices which may be used by the gateway system to determine the optimization illustrated by FIG. 6.

### DETAILED DESCRIPTION

According to a non-limiting example, a situational awareness system is described. The system comprises a processor and memory storing instructions executable by the processor. The instructions comprise to: determine at least one object of interest (OOI) relative to a target vehicle; determine an assignment optimization at least one of a plurality of mobile devices to the at least one object of interest; and assign the at least one of the plurality of mobile devices to the at least one object of interest.

According to at least one example of the system described above, the at least one OOI is in an occluded state.

According to at least one example of the system described above, the assigning further comprises commanding the at least one of the plurality of mobile devices to enter a follow mode with respect to the at least one OOI.

According to at least one example of the system described above, the follow mode includes the at least one of the plurality of mobile devices hovering above the OOI.

According to at least one example of the system described above, the instructions further comprising to: receive object of interest (OOI) data, regarding the at least one OOI, from the at least one of the plurality of mobile devices assigned to the at least one OOI; and transmit situational awareness (SA) data to the target vehicle, wherein the SA data is based on the OOI data.

According to at least one example of the system described above, the assignment optimization includes using a cost function calculation.

According to at least one example of the system described above, the instructions further comprising to: use at least one optimization factor in the cost function.

According to at least one example of the system described above, the at least one optimization factor comprises at least one of an optimal distance factor, an optimal power factor, or an optimal availability factor.

According to at least one example of the system described above, the cost function includes:

$${\hat{X}}^{t} = argmin \{ {Σ}_{i = 1}^{{N}^{t}} {Σ}_{j = 1}^{M} {X}_{i , j}^{t} {C}_{i , j}^{t} \} , subject to \text{:}$$

$${Σ}_{i = 1}^{{N}^{t}} {X}_{i , j}^{t} \leq 1 ∀ j and$$

$${\sum }_{j = 1}^{M} {X}_{i , j}^{t} = 1 ∀ i$$

wherein \hat{X}^{t} is an optimal estimate of the matrix X^{t}, a summation Σᵢ₌₁^{N}^{^{t}} accounts for indexed objects of interest, a summation Σⱼ₌₁^{M} accounts for indexed mobile devices, X_{i,j}^{t} is an assignment matrix defined by mobile devices and objects of interest, and C_{i,j}^{t} is cost value of an i^{th}, j^{th} assignment element of a cost matrix of size N^{t}×M at a time t.

According to at least one example of the system described above, wherein C_{i,j}^{t} represents the optimal distance factor, the optimal power factor, the optimal availability factor, or a combination thereof.

According to at least one example of the system described above, further comprising the at least one of the plurality of mobile devices.

According to at least one example of the system described above, wherein a gateway system comprises the processor and memory, wherein the gateway system further comprises a wireless transceiver configured to communicate with the at least one of the plurality of mobile devices and with the target vehicle.

According to another illustrative example, another situational awareness system is described. The system comprises a processor and memory storing instructions executable by the processor. The instructions comprise to: determine at least one object of interest (OOI) in an occluded state, relative to a target vehicle; determine an assignment optimization at least one of a plurality of mobile devices to the at least one object of interest; and assign the at least one of the plurality of mobile devices to the at least one object of interest.

According to another illustrative example, a method is described. The method comprises: determining at least one object of interest (OOI) relative to a target vehicle; determining an assignment optimization at least one of a plurality of mobile devices to the at least one OOI; and assigning the at least one of the plurality of mobile devices to the at least one OOI.

According to at least one example of the method described above, the at least one OOI is in an occluded state.

According to at least one example of the method described above, the assigning further comprises commanding the at least one of the plurality of mobile devices to enter a follow mode with respect to the at least one OOI.

According to at least one example of the method described above, the follow mode includes the at least one of the plurality of mobile devices hovering above the OOI.

According to at least one example of the method described above, the follow mode comprises hovering above the OOI within a predefined tolerance of a vertical axis of the OOI.

According to at least one example of the method described above, the assignment optimization includes using a cost function calculation.

According to at least one example of the method described above, the cost function calculation comprises at least one optimization factor, wherein the at least one optimization factor comprises at least one of an optimal distance factor, an optimal power factor, or an optimal availability factor.

According to one example, any combination of the instructions or instruction limitations set forth above may be used in combination with one another.

According to one example, any combination of the method steps or method limitations set forth above may be used in combination with one another.

According to the at least one example set forth above, a computing device comprising a processor and memory is disclosed that is programmed to execute any combination of the examples of the method(s) set forth above.

According to the at least one example, a computer program product is disclosed that includes a computer readable medium that stores instructions executable by a computer processor, wherein the instructions include any combination of the examples of the method(s) set forth above.

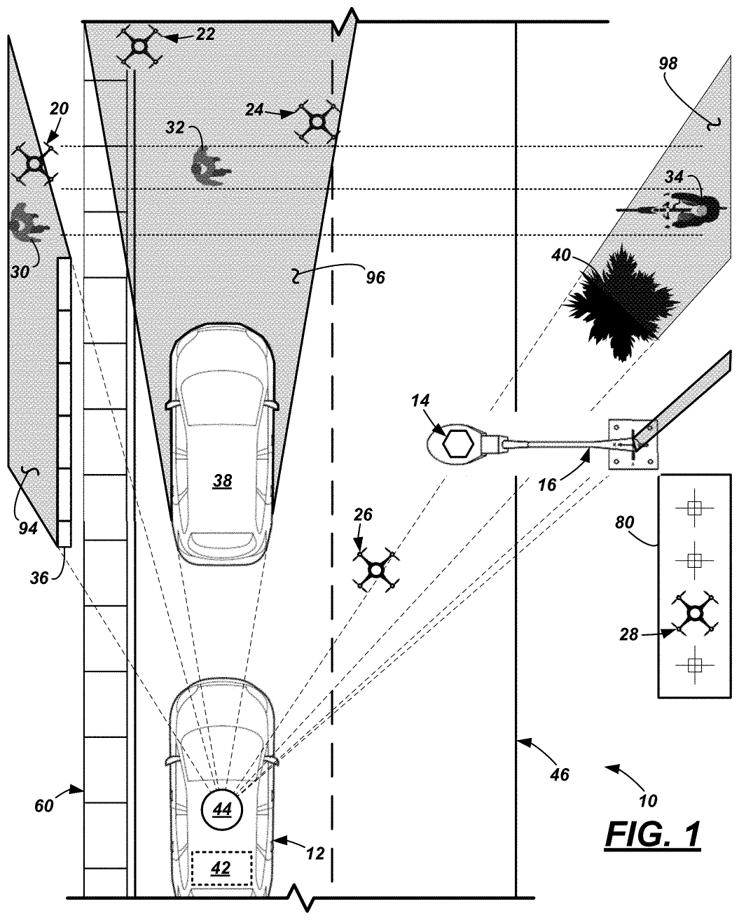

Turning now to the figures, wherein like reference numbers denote like or similar elements, features, or functions, a situational awareness (SA) system 10 is shown that may be configured, among other things, to provide occluded-object data to a target vehicle 12—the occluded-object data being pertinent to operating vehicle 12 in an autonomous mode. More particularly, the system 10 may comprise a gateway (GW) system 14 (e.g., coupled to any suitable infrastructure 16) and a plurality of mobile devices 20, 22, 24, 26, 28 which provide tracking data (also referred to as object of interest data) to system 14 (e.g., the object of interest data pertaining to one or more physical objects of interest 30, 32, 34, each of the objects of interest being in an occluded state (relative to vehicle 12)). As used herein, an object of interest is any physical object that—if detected by target vehicle 12—would cause the target vehicle 12 (operating in an autonomous mode) to determine whether to change its velocity (i.e., its speed, direction, or combination thereof). And as used herein, an occluded state refers to an object of interest being at least partially occluded from a perspective of a sensor on a target vehicle (e.g., such as vehicle 12). Typically, the object of interest 30, 32, 34 is occluded (with respect to vehicle 12) by an occluding object. FIG. 1 illustrates several non-limiting examples of occluding objects 36, 38, 40—shown respectively (and at least temporarily) interposed between vehicle 12 and the respective objects of interest 30, 32, 34.

As will be described in detail below, the GW system 14 may be programmed, based on the object of interest data, to optimize a determination of which mobile devices 20-28 should be uniquely assigned to the objects of interest 30-32, wherein assignment of a mobile device to a respective object of interest includes that mobile device establishing an aerial point-of-view of the object of interest and thereby providing additional information regarding said object of interest. Accordingly, for each object of interest 30-32, system 14 may receive object of interest (OOI) data via the assigned mobile device. According to some examples, this may occur repeatedly until the respective object of interest 30-34 is no longer in the occluded state, until the object of interest 30-34 is no longer within a predetermined range of the system 14, until the assigned mobile device reaches a low power state and needs to be handed-off to a newly-assigned mobile device, or until the object of interest 30-34 ceases to be of interest for any other suitable reason. Accordingly, for each of the objects of interest 30-34, system 14 repeatedly wirelessly may communicate situational awareness (SA) data (which may comprise object of interest data) to vehicle 12 so that the vehicle 12 may utilize this information to desirably navigate itself. Examples of this process will be explained in greater detail below—following a description of the SA system 10.

Target vehicle 12 is illustrated as a passenger vehicle. However, vehicle 12 could be any other suitable vehicle type, including a truck, a sports utility vehicle (SUV), a recreational vehicle, a bus, aircraft, marine vessel, or the like that comprises an autonomous driving system 42 and one or more sensors 44.

Autonomous driving system 42 may comprise any suitable computing device(s) which receive information from sensor(s) 44 and, based on such sensor information, control movement of vehicle 12 on exemplary roadway 46. For example, system 42 may include hardware and application-specific code (e.g., software instructions) that control acceleration, braking, and steering of vehicle 12. In at least one example, system 42 is programmed and configured to operate vehicle 12 in at least one autonomous mode—e.g., enabling vehicle 12 to operate with some user assistance (partial autonomy) or without any user assistance (full autonomy). For purposes of this disclosure, predetermined autonomous modes (e.g., defined as levels 0-5), as set forth by the Society of Automotive Engineers (SAE), may be used. For example, according to levels 0-2, a human driver monitors or controls the majority of the driving tasks, often with no help from the vehicle 12. For example, at level 0 (“no automation”), a human driver is responsible for all vehicle operations. At level 1 (“driver assistance”), vehicle 12 sometimes assists with steering, acceleration, or braking, but the driver is still responsible for the vast majority of the vehicle control. At level 2 (“partial automation”), vehicle 12 can control steering, acceleration, and braking under certain circumstances without human interaction. At levels 3-5, vehicle 12 assumes more driving-related tasks. At level 3 (“conditional automation”), vehicle 12 can handle steering, acceleration, and braking under certain circumstances, as well as monitoring of the driving environment. Level 3 may require the driver to intervene occasionally, however. At level 4 (“high automation”), vehicle 12 can handle the same tasks as at level 3 but without relying on the driver to intervene in certain driving modes. And at level 5 (“full automation”), vehicle 12 can handle all tasks without any driver intervention.

Sensor(s) 44 may comprise any electronic hardware devices configured to receive information regarding a region proximate to and/or around vehicle 12. In some instances, sensors 44 may be configured to receive information regarding the vehicle functions which relate to the vehicle's surroundings (e.g., a lane-departure warning function, a lane-keeping assist function, an adaptive cruise function, or the like). Each of the sensor(s) 44 may be coupled directly or indirectly to a computing device—e.g., including but not limited to a computing device of the autonomous driving system 42. In this manner, sensor data from any of the respective sensors 44 may be communicated to (and used by) the autonomous driving system 42. Non-limiting examples of sensor(s) 44 include one or more camera sensors (e.g., which include day cameras (e.g., 380-740 nanometers (nm)) and those capable of receiving at least some infrared data (e.g., 740 nm-40 micrometers (μall)), one or more camera light detection and ranging (LIDAR) sensors, one or more camera millimeter (mm) radio detection and ranging (RADAR) sensors, and/or one or more camera ultrasonic sensors.

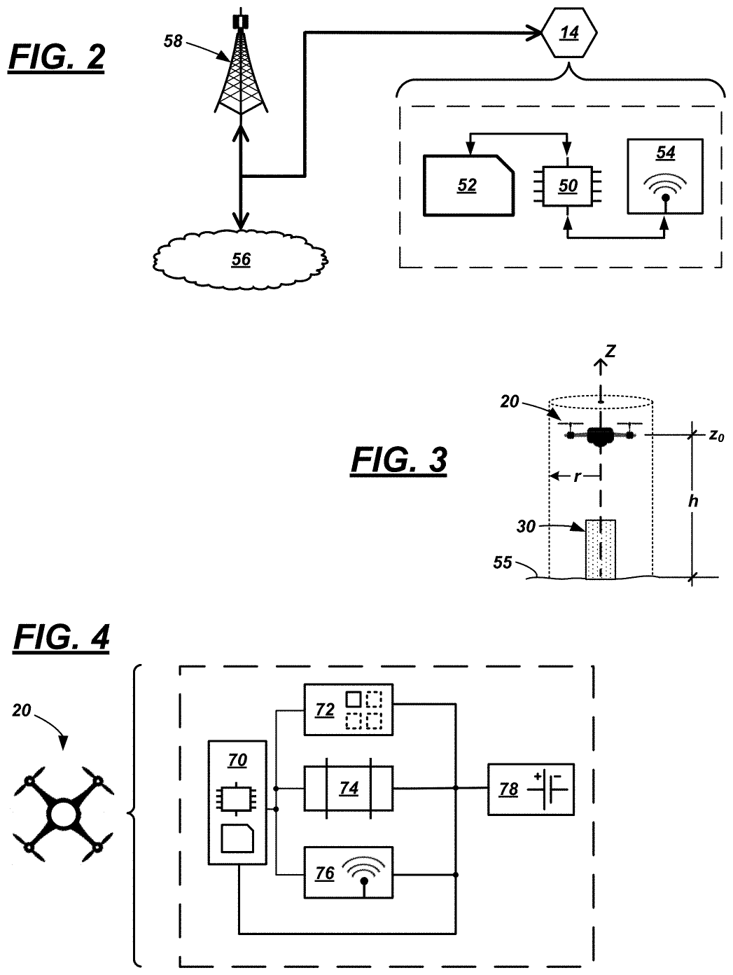

Gateway (GW) system 14 may comprise any suitable electronics for communicating with vehicle 12 and mobile devices 20-28 and for controlling at least some operational functions of mobile devices 20-28. As shown in FIG. 2, the system 14 may comprise a processor 50 programmed to process and/or execute digital instructions, memory 52, and a wireless transceiver 54 for communicating with mobile devices 20-28 and vehicle 12. Processor 50 may be any electronic device or circuit configured to process object of interest data received from the mobile devices 20-28 and to command/control devices 20-28. Non-limiting examples of processor 50 include a microprocessor, a microcontroller or controller, an application specific integrated circuit (ASIC), a field-programmable gate array (FPGA), one or more electrical circuits comprising discrete digital and/or analog electronic components arranged to perform predetermined tasks or instructions, etc.—just to name a few.

And a few non-limiting examples of instructions—storable in memory 52 and executable by processor 50—include: to receive object of interest data from mobile devices 20-28; to optimize assignment of a mobile device (e.g., one of 20-28) to an object of interest (e.g., one of 30-34); to command the assigned mobile device to enter a follow mode with respect to the particular object of interest; to hover above the particular object of interest in the follow mode (e.g., see FIG. 3)—e.g., within a predefined tolerance (r) of a vertical axis (Z) of the object of interest (e.g., object of interest 30; and at least a predefined height (h) (e.g., having a value z₀) above the object of interest 30 or above a ground level 55); to receive object of interest (OOI) data from the assigned mobile device; to provide that OOI data to the target vehicle 12 so that the target vehicle 12—operating in an autonomous mode—may utilize the OOI data to execute autonomous driving; to use that OOI data to determine situational awareness (SA) data (e.g., a conversion of or change to the OOI data), wherein the process includes providing the SA data to the target vehicle 12 so that the target vehicle 12—operating in an autonomous mode—may utilize the SA data to execute autonomous driving. Additional and more specific examples of instructions may be used instead of and/or in addition to these examples. Furthermore, these and other instructions may be executed for any number of mobile devices 20-28 at least partially concurrently (e.g., depending upon the quantity of objects of interest, relative to target vehicle 12). Still further, these and other instructions may be executed for multiple target vehicles 12 (although only one target vehicle is shown by way of example).

These instructions and the example processes described below are merely embodiments and are not intended to be limiting. In at least one example, processor 50 executes a computer program product stored on a non-transitory computer-readable storage medium (e.g., of memory 52). As used herein, a computer program product means a set of instructions (e.g., also known as: ‘software’ or ‘firmware code,’ an algorithm, or the like).

Memory 52 may include any non-transitory computer usable or readable medium, which may include one or more storage devices or articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 52 may store one or more computer program products which may be embodied as software, firmware, or other programming instructions executable by the processor 50—including but not limited to the instruction examples set forth above.

Wireless transceiver 54 may comprise any suitable electronics hardware configured to send and/or receive wireless data via any suitable radio frequency (RF) and any suitable protocol. According to one non-limiting example, transceiver 54 includes one or more wireless chipsets (not shown)—e.g., a short-range wireless communication (SRWC) chipset, a cellular chipset, or a combination thereof. Thus, transceiver 54 may utilize cellular technology (e.g., LTE, GSM, CDMA, and/or other cellular communication protocols), short-range wireless communication technology (e.g., Dedicated Short Range Communication (DSRC), a Digital Living Network Alliance (DLNA) protocol), Wi-Fi, Wi-Fi Direct, Bluetooth, Bluetooth Low Energy (BLE), and/or other short-range wireless communication protocols), or a combination thereof and/or may form part of any suitable mesh network. Accordingly, transceiver 54 may engage in so-called vehicle-to-vehicle (V2V) and vehicle-to-everything (V2X) communications. Typically, transceiver 54 is electronically coupled to processor 50 and transmits in accordance with an instruction from processor 50; similarly, transceiver 54 wirelessly may receive data and provide the data to processor 50 which ultimately may determine how to utilize the data.

In at least some examples, GW system 14 may comprise other devices (not shown). For example, GW system 14 may comprise any additional devices such as: a camera sensor, LIDAR sensor, a millimeter radar sensor, other sensors, and/or other communication devices (e.g., including those that broadcast (e.g., to all vehicles) signal and time phase (SPAT) data, localization or other map data, vehicle ad hoc network (VANET) data, data regarding static-hazards on roadway 46, official vehicle data (e.g., police and fire vehicle data), or the like.

FIG. 2 also illustrates that GW system 14 also may be communicatively coupled to a land communications network 56 and/or a wireless communications network 58. For example, the land communications network 56 may enable connectivity (of the GW system 14) to a public switched telephone network (PSTN) such as that used to provide hardwired telephony, packet-switched data communications, internet infrastructure, and the like. And the wireless communications network 58 may enable connectivity (of the GW system 14) to any suitable short-range and/or long-range wireless network. Thus, in at least one example, wireless communication network 58 includes any suitable cellular infrastructure that could include eNodeBs, serving gateways, base station transceivers, and the like. Further, network 58 may utilize any suitable existing or future cellular technology (e.g., including LTE, CDMA, GSM, etc.). Land and wireless communication networks 56, 58 may be communicatively coupled to another and to any other suitable public and/or private networks (not shown).

Returning to FIG. 1, infrastructure 16 may be any fixed structure that facilitates the operation or use of roadway 46 (or a pathway 60) and/or that supports or protects the roadway 46, the pathway 60, and/or the human users thereof. In the illustration, the infrastructure 16 is illustrated as a street lamp assembly; however, this is merely an example. Other non-limiting examples of infrastructure 16 include: a traffic control assembly (e.g., signage or traffic lamp), a bridge, a gate, other roadway signage, a building, railway or subway architecture, or the like. In at least one example, the GW system 14 may be mounted to infrastructure 16 at an elevated (e.g., so-called ‘bird's eye’) position (e.g., 15-20 feet high)—e.g., thereby having line-of-sight (LOS) with respect to vehicle traffic on roadway 46 and/or pedestrian traffic pathway 60.

Now turning to the mobile devices 20-28, according to one example, each of the mobile devices 20-28 may be identical. Therefore, only one of the devices (device 20) will be described in detail; however, it should be appreciated that other configurations, arrangements, and types of mobile devices may be used in other examples. See FIGS. 1 and 4.

As used herein, a mobile device is an electronic observation platform that is configured: to receive position and heading information regarding objects of interest 30-34 via one or more onboard sensors and provide this information as object of interest data to gateway (GW) system 14; and to execute a follow mode, as instructed by gateway system 14. As shown in FIG. 4, one non-limiting example of mobile device 20 is an unmanned aerial vehicle (UAV) (also known as a ‘drone’) comprising a computer 70, one or more sensors 72 (e.g., a camera sensor, a LIDAR sensor, another sensor, or a combination thereof), a drive system 74, a wireless transceiver 76, and a rechargeable power source 78 coupled to each of the computer 70, sensor(s) 72, drive system 74, and transceiver 76 to provide power thereto.

Computer 70 may comprise any suitable processor, memory, and the like, and the processor of computer 70 may be programmed: to control the drive system 74 thereby controlling the speed and movement of the mobile device 20 (e.g., fly the drone); to receive sensor data from sensor(s) 72; to determine its position relative to its environment and other objects in the environment—e.g., to determine localization; to communicate with GW system 14 (including to communicate object of interest data thereto, which object of interest data may be derived from the sensor data); to execute instructions commanded by GW system 14, including to enter a follow-mode to follow an object of interest (e.g., by hovering thereover); to determine a low power state (e.g., of the power source 78); to return to a charging station 80 (such as is shown in FIG. 1); and to identify to GW system 14 its availability state (e.g., “available” or “not available”) among other programming instructions.

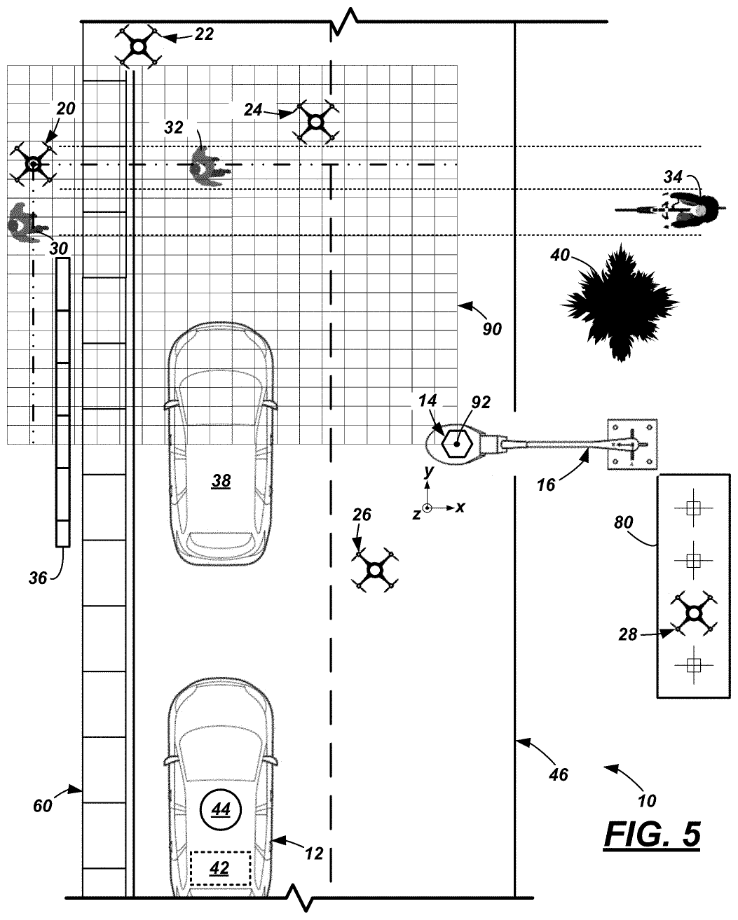

According to at least one example, computer 70 may determine a three-dimensional (3D) frame of reference of mobile device 20 and determine its position within that frame of reference. According to one example, the GW system 14 may be an origin of the frame of reference; however, this is merely an example. FIG. 5 illustrates an example of a portion of a frame of reference 90, wherein according to the example, GW system 14 is located at an origin 92 (0, 0, 0), and mobile device 20 is located at an example position (−18.8 units, −14.7 units, 0 units). Determining and using this frame of reference may include using other so-called smart infrastructure (e.g., wireless) nodes, so-called smart vehicles, and the like.

The sensor(s) 72 and wireless transceiver 76 may be similar to and/or operate similarly to the sensor(s) 44 and transceiver 54 (respectively described above), except of course that these electronics form part of the hardware platform of mobile device 20 instead. Thus, sensors 72 may provide data to computer 70, and transceiver 76 may enable communication between at least mobile device 20 and GW system 14—e.g., computer 70 controlling what object of interest data to send to GW system 14 (e.g., based at least on commands from system 14 and/or based at least on sensor data received via sensor(s) 72). Therefore, sensor(s) 44 and transceiver 54 will not be described in detail here.

In at least some examples, sensor(s) 72 may be used by computer 70 to determine a range value (e.g., with respect to GW system 14). In this manner, mobile device 20 may remain within a predetermined range (e.g., radius) of GW system 14. In one example, this predetermined range is a line-of-sight (LOS) range—e.g., range may be determined using received signal strength indication (RSSI), time-of-flight (ToF) data, angle-of-arrival (AoA) data, and/or the like). As will be described more below, mobile device 20 may determine a range value and compare this with a predetermined threshold range; when the range value exceeds the threshold range, the mobile device 20 may cease a follow mode of an object of interest.

The drive system 74 may comprise a motor and propulsion system (neither is shown). For example, drive system 74 may comprise any suitable controls (e.g., roll, pitch, yaw, throttle, etc.) so that mobile device 20 may move in an upward-direction, in a downward-direction, in a fore-direction, in an aft-direction, in a starboard-direction, in a port-direction, or in a direction that suitably combines any combination of directions. In at least one example, the system 74 may be an electric drive, employing hardware known in the art.

Power source 78 may be an electric battery of any suitable composition. The source 78 may be rechargeable—e.g., using contact- or contactless recharging. In at least one example, the mobile device 20 may land on charging station 80 and based on landing on a predetermined region (on station 80), power source 78 of mobile device 20 inductively may receive electric charge. When power source 78 stores less than a threshold power quantity, computer 70 may determine that an available state of mobile device 20 is ‘not available.’ Conversely, in at least some examples, when power source 78 stores more than or equal to the threshold power quantity, computer 70 may determine that the available state of mobile device 20 is ‘available.’

Returning to FIG. 1, the illustration also shows non-limiting examples of occluding objects (e.g., 36, 38, 40). For example, a wall or barrier (occluding object 36) is shown (e.g., which is positioned between sensor 44 of target vehicle 12 and object of interest 30 (e.g., a pedestrian approaching roadway 46)). And for example, a vehicle (occluding object 38) is shown (e.g., which is positioned between sensor 44 and object of interest 32 (e.g., a pedestrian crossing roadway 46)). And for example, a tree (occluding object 40) is shown (e.g., which is positioned between sensor 44 and object of interest 34 (e.g., a cyclist approaching roadway 46)).

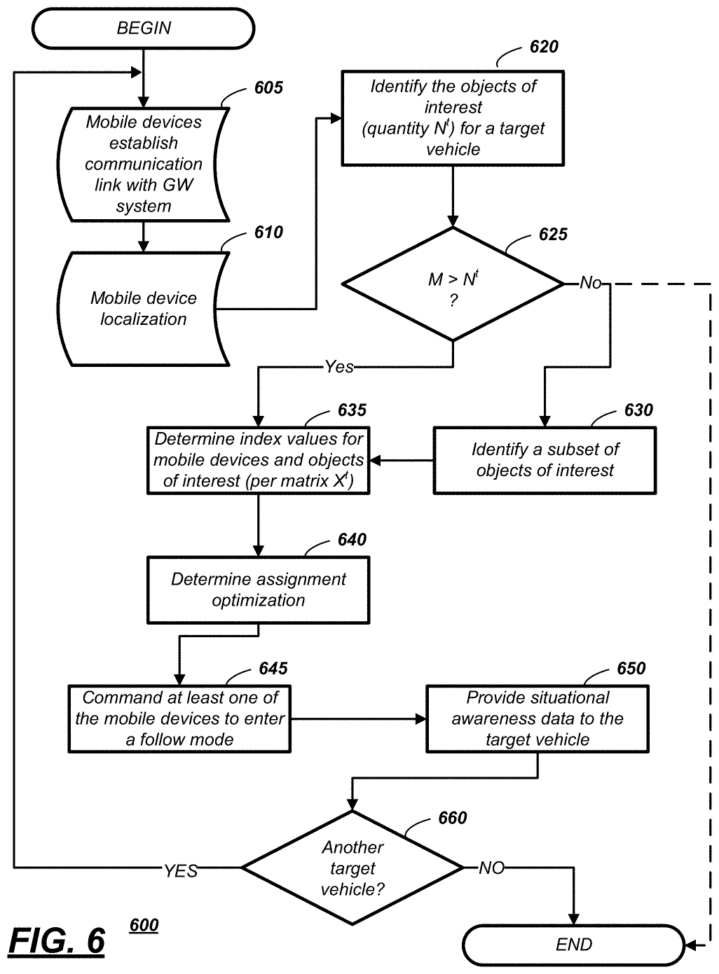

Turning now to FIG. 6, a process 600 is illustrated—e.g., showing how a plurality (M) of mobile devices may be deployed in an optimal fashion to observe a plurality (N^{t}) of objects on interest which are obstructed from the view of sensor(s) 44 (of target vehicle 12) by any suitable quantity of occluding objects. For purposes of explaining process 600, the quantity M can refer to mobile devices 20-28, the quantity N^{t} of objects of interest (at an instantaneous time t) can refer to objects of interest 30-34, and the occluding objects may be occluding objects 36-40. In the discussion that follows, GW system 14 determines an optimal deployment of mobile devices relative to a vehicle (i.e., target vehicle 12)—e.g., minimizing deployment time of mobile devices, and thereby conserving mobile device resources and providing more up-to-date information to the GW system 14 and consequently more up-to-date information to vehicle 12. While described below in the context of one target vehicle 12, it should be appreciated that GW system 14 may execute similar or identical instructions and/or operations for additional target vehicles serially and/or at least partially concurrently with the process described below for vehicle 12.

Further, in at least one example, different mobile devices are deployed for each additional vehicle; however, this is not required. E.g., some occluding objects may block line-of-sight (LOS) for multiple target vehicles, and the process 600 may be employed wherein one or more mobile devices are commonly assigned to an object of interest for multiple target vehicles.

Thus, with reference to target vehicle 12, process 600 may begin with block 605 wherein mobile devices 20-28 may establish any suitable wireless communication link with GW system 14. The link may utilize Dedicated Short-Range Communication (DSRC), Wi-Fi, or any other suitable technology.

Block 610 may follow. In block 610, the mobile devices 20-28 may perform any suitable localization scheme. In this manner, mobile devices 20-28 may be able to identify their respective positions—e.g., relative to GW system 14 and/or target vehicle 12. While not required, mobile device localization may include communication with GW system 14.

As discussed above, FIG. 5 illustrates a top view of a 3D map which may be utilized by the mobile devices 20-28, wherein GW system 14 is the origin 92; however, this is merely an example. In at least some examples, localization may include storing localization data in read-only memory, flash memory, or other long-term memory (e.g., of the GW system 14 and/or mobile devices 20-28), wherein the localization data may identify fixed features in the local environment (e.g., such as infrastructure 16, the roadway 46, the pathway 60, the wall 36, the tree 40, and the like). Further, such fixed features may be used by mobile devices 20-28 to execute localization in block 610 or to execute localization at any other suitable time during process 600.

Block 620 may follow block 610. In block 620, processor 50 of GW system 14 may identify N^{t} objects of interest 30-34 at an instantaneous time t. Time t may be a clock time or any other suitable time determined using any suitable timer of GW system 14.

Block 620 may include processor 50 calculating two- and/or three-dimensional occluded regions 94, 96, 98 (see FIG. 1) relative to sensor 44 of target vehicle 12. More particularly, these regions 94-98 may be a volumetric representation of three-dimensional space which cannot be adequately observed by sensor(s) 44 due to the respective occluding objects 36-40. Still further, each of these regions 94-98 may at least partially include at least one object of interest (e.g., continuing with the example of FIG. 1, quantity N^{t} may be ‘3 objects of interest,’ e.g., such as objects 30-34). In at least some examples, these regions 94-98 are dynamic; i.e., they change in size, shape, and relevance due to both the target vehicle 12 potentially moving, as well as the objects of interest 30-34 potentially moving.

In block 625 which follows, processor 50 (GW system 14) may determine whether the quantity M of mobile devices 20-28 is greater than the quantity N^{t} of objects of interest 30-34. When the quantity M does not exceed the quantity N^{t}, then process 600 may proceed to block 630. However, when M is greater than N^{t}, then process 600 may proceed to block 635.

In block 630, processor 50 may identify any suitable subset of objects of interest so that M>N^{t} and assign the quantity of subsets to N^{t}. In some instances, this may require assigning a risk priority value to each of the objects of interest N^{t} and utilizing in process 600 (in the subset) only those objects of interest with the highest risk of collision, human or property injury, or the like. Following block 630, process 600 may proceed to block 635 as well. Alternatively, if M≤N^{t}, process 600 could skip block 630 and end.

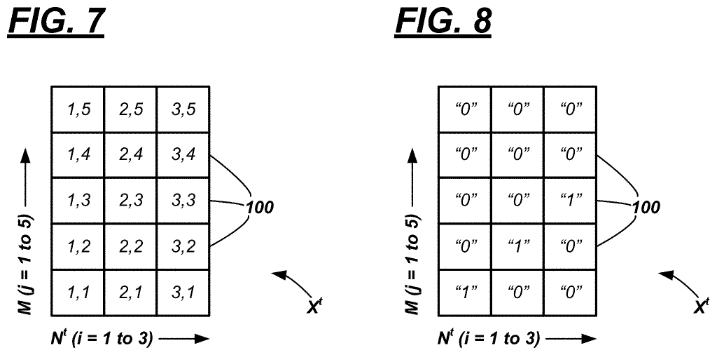

In block 635, processor 50 may determine index values for a matrix X^{t}. The matrix X^{t} may comprise M mobile devices and N^{t} objects of interest—e.g., N^{t}×M. In the example calculations that follow, objects of interest N^{t} may be indexed using ‘i,’ and mobile devices M may be indexed using ‘j.’ Thus, any one of matrix elements 100 may be represented mathematically by X_{i,j}^{t} (see FIGS. 7-8).

FIG. 7 continues with the example set forth above—e.g., showing an example matrix X^{t} having fifteen elements 100, wherein i=3 and j=5; however, this is merely an example. Regardless of the size of the matrix, each element 100 of matrix X^{t} may have a binary value—e.g., each element 100 may store a value of zero (“0”) or of one (“1”). According to one example, an element having a value of “1” means that the associated mobile device (the device having the respective index j) is assigned to the respective object of interest (the object having the respective index i). As discussed more below, once a mobile device is assigned to an object of interest, the mobile device then enters a follow mode (e.g. and can hover above the object) and provide object of interest data to the GW system 14. Continuing with the binary example, an element having a value of “0” means that the associated mobile device is not assigned to the respective object of interest.

FIG. 8 shows illustrative values of the matrix X^{t}, which mobile devices are assigned to which objects of interest, and which mobile device(s) are not assigned to an object of interest. For example, consider mobile devices 20, 22, 24, 26, 28 being identified mathematically as mobile device indices j=1, 2, 3, 4, and 5, respectively. Similarly, consider objects of interest 30, 32, 34 being identified mathematically as object of interest indices i=1, 2, and 3, respectively. According to this matrix example, (compare FIGS. 1 and 8), processor 50 of GW system 14 has assigned mobile device 20 to object of interest 30 (X_{1,1}^{t}=“1”), processor 50 has assigned mobile device 22 to object of interest 32 (X_{2,2}^{t}=“1”), processor 50 has assigned mobile device 24 to object of interest 34 (X_{3,3}^{t}=“1”), and processor 50 has not assigned mobile device 26 or mobile device 28 to an object of interest (X_{1,4}^{t}=X_{2,4}^{t}=X_{3,4}^{t}=“0” and (X_{1,5}^{t}=X_{2,5}^{t}=X_{3,5}^{t}=“0”). It should be appreciated that at this stage of the process, however, these values of “0” and “1” may not yet be determined. Thus, FIG. 8 is merely to preview an example of how GW system 14 may assign and retain a status of the mobile devices 20-28 with respect to objects of interest 30-34.

Returning to FIG. 6, block 640 follows the indexing in block 635. In block 640, processor 50 (of GW system 14) may determine an assignment optimization; i.e., processor 50 may determine which of mobile devices 20-28 should be assigned to objects of interest 30-34, wherein the assignment is a one-to-one assignment. Stated differently, processor 50 selectively may determine which mobile device should be uniquely and optimally assigned to each object of interest.

Processor 50 may execute this optimization using one or more optimization factors. As used herein, an optimization factor is a mathematical expression of a cost function (e.g., a cost function also can be referred to as a loss function). Non-limiting examples of optimization factors include: an optimal distance factor (e.g., accounting for plurality of distances between the mobile devices 20-28 and the respective objects of interest 30-34), an optimal power factor (e.g., accounting for a plurality of power levels of the mobile devices 20-28), and an optimal availability factor (e.g., accounting for a plurality of availability states of the mobile devices 20-28).

According to one example of block 640, processor 50 executes, among other things, a cost function identical or similar to Equation (1).

$${\hat{X}}^{t} = argmin \{ {Σ}_{i = 1}^{{N}^{t}} {Σ}_{j = 1}^{M} {X}_{i , j}^{t} {C}_{i , j}^{t} \} , subject to \text{:} \\ {Σ}_{i = 1}^{{N}^{t}} {X}_{i , j}^{t} \leq 1 ∀ j and \\ {\sum }_{j = 1}^{M} {X}_{i , j}^{t} = 1 ∀ i \qquad Equation ( 1 )$$

Referring to Equation (1), \hat{X}^{t} is an optimal estimate of the matrix X^{t}, the summation Σᵢ₌₁^{N}^{^{t}} accounts for all indexed objects of interest (e.g., 30-34), the summation Σⱼ₌₁^{M} accounts for all indexed mobile devices (e.g., 20-28), X_{i,j}^{t} refers to the assignment matrix described above, and C_{i,j}^{t}is cost value of an i^{th} assignment element of a cost matrix of size N^{t}×M at a time t. As discussed above, X_{i,j}^{t} can be a zero (“0”) or a one (“1”).

In at least one example, an optimization factor is used (comprising an optimal distance factor). For example, processor 50 may determine an optimization in block 640 by substituting C_{i,j}^{t}, shown in Equation (2), for C_{i,j}^{t} shown in Equation (1).

Equation (2)

C_{i,j}^{t}=∥pⱼ^{t}−(qᵢ^{t}+[0,0,z₀])∥ₜ₂

Referring to Equation (2), pⱼ^{t} is a three-dimensional (3D) vector which can be represented as [xⱼ, yⱼ, zⱼ] thereby illustrating a 3D position of a j^{th} mobile device at time t, qᵢ^{t} is a 3D vector which can be represented as [xᵢ, yᵢ , 0] thereby illustrating a 2D position of a i^{th} object of interest at time t, and ∥α∥ₜ₂ is a L2 norm defined for a vector α as Σ_{d=1}^{F} α_{d}², wherein F is a quantity of scalar elements α_{d}. Thus, Equation (2) may determine an optimization based on relative locations of the mobile devices 20-28 and objects of interest 30-34. Further, representing a 2D position of an i^{th} object of interest is merely an example; that said, in other examples, a 3D position of an i^{t h} object of interest may be used instead. Still further, in other examples, an L1 norm may be used instead of an L2 norm.

According to another example of block 640, another optimization factor may be used (comprising an optimal power factor). In this example in block 640 (which follows), the calculation accounts for both the optimal distance factor and an optimal power factor; however, this is merely an example (e.g., the optimal power factor may be used without the optimal distance factor and/or with other different factors). In the example, a different substitution for C_{i,j}^{t} is shown in Equation (3), wherein C_{i,h}^{t} accounts for both distances and power levels; however, this is merely an example.

$${C}_{i , j}^{t} = ( 1 - {λ}_{β} ) \frac{1}{E} {‖ {p}_{j}^{t} - ( {q}_{i}^{t} + [ 0 , 0 , {z}_{0} ] ) ‖}_{l 2} + {λ}_{β} ( 1 - {B}_{j}^{t} ) \qquad Equation ( 3 )$$

For sake of brevity only, elements of Equation (3) which are also shown in Equation (2) will not be re-explained. Per the example shown in Equation (3), E is a predetermined constant that can be used to normalize a distance error to be of maximum possible distance of unity or one (“1”), λ_{β} is a predetermined scalar weighting-value that is configurable (e.g., 0-1), and Bⱼ^{t} is a value (e.g., 0-1) that is a linear representation of a battery life of power source 78 (of the j ^{th} mobile device at time t, wherein a value of ‘1’ represents a full charge, wherein a value of ‘0’ represents no charge).

In Equation (3), weight λ_{β} serves to balance a trade-off between the optimal distance factor and the optimal power factor. Accordingly, when the value of weight λ_{β} is ‘1,’ then the first term in Equation (3) is zero and the optimization is driven by the optimal power factor. Similarly, when the value of weight λ_{β} is ‘0,’ then the second term in Equation (3) is zero and the optimization is driven by the optimal distance factor. Still further, any values between 0 and 1 weigh the optimization more toward the optimal distance factor and less toward the optimal power factor, or vice-versa.

According to another example of block 640, another optimization factor may be used (comprising an optimal availability factor); see Equation (4) below. In this example in block 640 (which follows), the calculation accounts for each of the optimal distance, the optimal power, and the optimal availability factors; however, (as discussed above) this is merely an example. E.g., any of the optimization factors may be used individually or collectively with one another and/or with other factors now shown but contemplated herein.

$${C}_{i , j}^{t} = ( 1 - {λ}_{j}^{t} ) ( 1 - {λ}_{β} ) \frac{1}{E} {‖ {p}_{j}^{t} - ( {q}_{i}^{t} + [ 0 , 0 , {z}_{0} ] ) ‖}_{l 2} + {λ}_{β} ( 1 - {B}_{j}^{t} ) * ( 1 - {λ}_{j}^{t} ) + {λ}_{j}^{t} \qquad Equation ( 4 )$$

For sake of brevity only, elements of Equation (4) which are also shown in Equations (2) and (3) will not be re-explained. Per the example shown in Equation (4), λⱼ^{t} is another predetermined scalar weighting-value that is configurable (e.g., 0-1). Weight λⱼ^{t} serves to balance a trade-off between the optimal distance factor, the optimal power factor, and the optimal availability factor. Accordingly, when the value of weight λⱼ^{t} is ‘1,’ then the first and second terms in Equation (4) are zero, and the optimization is driven entirely by the optimal availability factor. And when the value of weight λⱼ^{t} is ‘0,’ then the second and third terms in Equation (4) are zero and the optimization is driven by the optimal distance factor and the optimal power factor. Still further, any values between 0 and 1 weigh the optimization more toward the optimal distance and power factors and less toward the optimal availability factor, or vice-versa.

Continuing with the illustrated example of FIG. 1, in block 640, GW system 14 may assign mobile device 20 to object of interest 30, mobile device 22 to object of interest 32, and mobile device 24 to object of interest 34. Mobile devices 26-28 may be deemed not optimal to this present situation. And in at least one example, mobile device 28 may be unsuitable as it is in an unavailable state—e.g., charging at charging station 80.

In FIG. 6, block 645 follows block 640. In block 645, GW system 14 may command at least one mobile device to enter a follow mode and hover above the identified objects of interest. Of course, since in block 625 the quantity of mobile devices exceeded the objects of interest, at least one mobile device will not be utilized during block 645. Continuing with the present example, mobile device 20 may be commanded to enter the follow mode with respect to object of interest 30, mobile device 22 may be commanded to enter the follow mode with respect to object of interest 32, and mobile device 24 may be commanded to enter the follow mode with respect to object of interest 34.

Following block 645, mobile devices 20-24 may gather position and heading information regarding the objects of interest 30-34, respectively. That is, each respective mobile device may gather information regarding a single object of interest.

In block 650 which follows, these mobile devices 20-24 may communicate wireless the object of interest (OOI) data to the GW system 14. In response, GW system 14 may communicate situational awareness (SA) data to the target vehicle 12 so that the target vehicle 12 may autonomously navigate in the region around the GW system 14. In one example, the OOI data is passed through (i.e., the SA data is the same as the OOI data). In other examples, the GW system 14 executes some processing to reconfigure the OOI data in another format or arrangement and sends this reformatted and/or re-arranged data (i.e., the SA data) to the vehicle 12.

Block 660 may follow block 650. In block 660, GW system 14 may determine whether to determine another assignment optimization for another target vehicle. If GW system 14 determines to execute process 600 for another target vehicle, the process proceeds to block 605 and may repeat (at least in part) for the other vehicle; else, process 600 may end.

Thus, there has been described a situational awareness system that may provide information to a vehicle operating in an autonomous mode. The system may comprise a gateway system which communicates with multiple mobile devices and provides information to the vehicle regarding objects that the vehicle may not perceive—e.g., objects of interest in an occluded state. More particularly, the gateway system may be programmed to optimize control over the mobile devices to most efficiently provide the vehicle situational awareness data.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Python, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above and are accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a processor; and
memory storing instructions executable by the processor, the instructions, comprising to:
determine at least one object of interest (OOI ) relative to a target vehicle;
determine an assignment optimization at least one of a plurality of mobile devices to the at least one OOI; and
assign the at least one of the plurality of mobile devices to the at least one OOI.

2. The system of claim 1, wherein the at least one OOI is in an occluded state.

3. The system of claim 1, wherein the assigning further comprises commanding the at least one of the plurality of mobile devices to enter a follow mode with respect to the at least one OOI.

4. The system of claim 3, wherein the follow mode includes the at least one of the plurality of mobile devices hovering above the OOI.

5. The system of claim 1, the instructions further comprising to: receive object of interest (OOI) data, regarding the at least one OOI, from the at least one of the plurality of mobile devices assigned to the at least one OOI; and transmit situational awareness (SA) data to the target vehicle, wherein the SA data is based on the OOI data.

6. The system of claim 1, wherein the assignment optimization includes using a cost function calculation.

7. The system of claim 6, the instructions further comprising to: use at least one optimization factor in the cost function.

8. The system of claim 7, wherein the at least one optimization factor comprises at least one of an optimal distance factor, an optimal power factor, or an optimal availability factor.

9. The system of claim 6, wherein the cost function includes:
$${\hat{X}}^{t} = argmin \{ {Σ}_{i = 1}^{{N}^{t}} {Σ}_{j = 1}^{M} {X}_{i , j}^{t} {C}_{i , j}^{t} \} , subject to \text{:}$$
$${Σ}_{i = 1}^{{N}^{t}} {X}_{i , j}^{t} \leq 1 ∀ j and$$
$${\sum }_{j = 1}^{M} {X}_{i , j}^{t} = 1 ∀ i$$
wherein \hat{X}^{t} is an optimal estimate of a matrix X^{t}, a summation Σᵢ₌₁^{N}^{^{t}} accounts for indexed objects of interest, a summation Σⱼ₌₁^{M} accounts for indexed mobile devices, X_{i,j}^{t} is an assignment matrix defined by mobile devices and objects of interest, and C_{i,j}^{t} is cost value of an i^{th}, j^{th} assignment element of a cost matrix of size N^{t}×M at a time t.

10. The system of claim 9, wherein C_{i,j}^{t} represents the optimal distance factor, the optimal power factor, the optimal availability factor, or a combination thereof.

11. The system of claim 1, further comprising the at least one of the plurality of mobile devices.

12. The system of claim 1, wherein a gateway system comprises the processor and memory, wherein the gateway system further comprises a wireless transceiver configured to communicate with the at least one of the plurality of mobile devices and with the target vehicle.

13. A system, comprising:
a processor; and
memory storing instructions executable by the processor, the instructions, comprising to:
determine at least one object of interest (OOI ) in an occluded state, relative to a target vehicle;
determine an assignment optimization at least one of a plurality of mobile devices to the at least one OOI; and
assign the at least one of the plurality of mobile devices to the at least one OOI.

14. A method, comprising:
determining at least one object of interest (OOI) relative to a target vehicle;
determining an assignment optimization at least one of a plurality of mobile devices to the at least one OOI; and
assigning the at least one of the plurality of mobile devices to the at least one OOI.

15. The method of claim 14, wherein the at least one OOI is in an occluded state.

16. The method of claim 14, wherein the assigning further comprises commanding the at least one of the plurality of mobile devices to enter a follow mode with respect to the at least one OOI.

17. The method of claim 16, wherein the follow mode includes the at least one of the plurality of mobile devices hovering above the OOI.

18. The method of claim 17, wherein the follow mode comprises hovering above the OOI within a predefined tolerance of a vertical axis of the OOI.

19. The method of claim 14, wherein the assignment optimization includes using a cost function calculation.

20. The method of claim 19, wherein the cost function calculation comprises at least one optimization factor, wherein the at least one optimization factor comprises at least one of an optimal distance factor, an optimal power factor, or an optimal availability factor.
